(19) United States
(12) Patent Application Publication
(10) Pub. No.: US 2008/0059281 A1
(43) Pub. Date: Mar. 6, 2008

(54) Systems and methods for product attribute analysis and product recommendation

(75) Inventors: Theodore Tower, Appleton, WI (US); Jason C. Cohen, Appleton, WI (US); Andrew D. Basehoar, Neenah, WI (US); Eric D. Johnson, Larsen, WI (US)

Correspondence Address: DORITY & MANNING, P.A., POST OFFICE BOX 1449, GREENVILLE, SC, 29602-1449, US

(73) Assignee: Kimberly-Clark Worldwide, Inc.

(21) Appl. No.: 11/512,757

(22) Filed: Aug. 30, 2006

(51) Int. Cl. G07G 1/00; G07F 7/00

(52) U.S. Cl. 705/10; 705/27

(57) ABSTRACT

Product quality data may be obtained using a computer-based survey application configured to present images to a survey participant. The participant may be prompted to provide qualitative data pertaining to at least one perceived attribute of the product, with the qualitative data associated with a particular region of the product, for example, with particular coordinates of an image. Data may be collected from a plurality of participants and stored in a database. The data may be correlated, analyzed, and presented in various forms, such as charts, displays, and overlays on the original images. The product quality data may be used in providing purchase guidance, such as product recommendations, to consumers. The purchase guidance data may be provided by a client device linked to one or more servers. The client device may include an in-store kiosk. The purchase guidance data may be provided as part of an e-commerce web site.

### BACKGROUND

The success or failure of a consumer (or other) product may depend on a number of factors, including product features, product design, advertising, reliability, and other attributes. Therefore, the successful manufacturer of consumer (or other) products is one who is able to identify and provide the attributes that best satisfy consumer desires. These desires may be met, for example, by redesigning and optimizing products, and advertising or otherwise marketing products in a way that appeals to consumers.

To gauge what does and what does not appeal to consumers, various techniques have been developed, such as surveys, focus groups, and the like. Surveys and focus groups may utilize questionnaires, handouts, free form or moderated discussions, and a variety of other suitable means to determine what aspects of a product or marketing plan are found desirable by consumers and which aspects are not desirable. Such techniques may utilize computers to ascertain consumer thoughts and/or to tabulate and statistically analyze results.

Much of the use of computers has been directed towards automating prior types of analysis and data collection which were formerly performed manually. For instance, surveys that were once performed using physical handouts may be performed online, for example. As another example, computer-based techniques may provide for indications of interest to be made via a computer interface rather than providing paper for free hand drawings or indications of interest.

However, such currently-existing schemes do not fully leverage the capabilities for data analysis and manipulation that are possible when the consumer data is natively collected in computer form.

Furthermore, advances in product design and configuration have lead to a myriad of options. While this poses a challenge to designers, marketers, and other providers of products, it also poses a challenge to product purchasers, as well. Such purchasers may benefit from assistance in facing what has been dubbed “the paradox of choice.”

### SUMMARY

The present subject matter includes disclosure of computer-based systems and methods for gathering and presenting qualitative product data provided by users, including consumers. The qualitative data is associated with specific areas or regions of a consumer (or other) product, which, for example, allows for a finer degree of understanding and analysis of the appealing and non-appealing aspects of the product. Such data may be presented in a form useful for product designers, for example, in order for such designers to refine, change, update, or otherwise address product configuration and attributes. Furthermore, the same data may be manipulated and analyzed to be presented in a format useful for marketing the product. For instance, data may be gathered from a plurality of consumers regarding perceived attributes for a plurality of competing products, and the qualitative data used as a basis for providing a purchase recommendation. Furthermore, such information may be used to substantiate or dispel an advertising claim.

Although this disclosure includes examples and discussion of systems in which consumer data is obtained, the teachings contained herein are not limited to systems which gather only consumer data. Instead, the systems and methods discussed herein are suitable for use with any type of user or users, where a “user” is any entity, including but not limited to a consumer, that interacts with the systems discussed herein, including those entities that provide data and those that receive data.

A method of quantifying product attributes can include graphically presenting at least one image of a subject using a product and prompting a plurality of users to each select at least one region of an image based on at least one perceived product attribute. The data defining the region selection or selections may be stored in a computer-readable form. The user may be prompted to provide, for each selected region, qualitative data associated with the selected region. For instance, the qualitative data may include an intensity rating of a perceived attribute, such as comfort or discomfort. The qualitative data may further include, for example, a description of the perceived attribute. Data relating to more than one attribute may be acquired. The qualitative data may include user suggestions, alterations, or other indications of how to change particular region(s) of products.

The qualitative data may be stored in a computer-readable form, wherein the qualitative data is associated with the respective selected region. Qualitative data provided by a plurality of users and the data reflecting the region selections made by those users and associated with the qualitative data may be correlated in a number of ways and presented in a user-readable form.

For example, correlating can include determining the extent to which multiple users select the same area(s) of the same product(s). Correlating may include defining a region of interest in the product image. The region of interest may comprise, for example, an area in the image that is selected by a number of users; furthermore, the region of interest may comprise an area that is not selected by a plurality of users. The region of interest may be defined, for example, by analyzing the qualitative data associated with the region, for example by determining areas selected by a plurality of different users to which relatively extreme intensity values were provided relative to other selected areas.

User-readable data based on the correlated data may be presented, for example, as an overlay on the original image. For instance, regions for which a plurality of users selected and provided extreme intensity values may be overlaying as a colored area on the particular region in the original image.

The qualitative data may include, for example, descriptive text, which may be typed directly by the user, or may be the result of speech or handwriting recognition functionality included, for example, with software through which the user provides region selections and qualitative data. Correlating the qualitative data may further include determining the extent to which a plurality of users use the same or substantially similar text to describe the same or substantially similar selected regions. A region of interest may be defined, for example, as a region for which a plurality of users selected the same area and for which the users all used a key word or key words in providing a description.

The method may further comprise obtaining descriptive text for particular regions of the product, wherein the descriptive text describes the regions using internal terminology. For instance, terminology used by design, manufacture, sales, or other personnel associated with providing the product may be utilized. Correlating may then include accessing the user-provided descriptive text for a region and correlating user terminology for that region with internally used terminology for that region.

Correlating may also take into account data other than qualitative data provided by the user. For instance, the order in which the user provides data may be considered, including the order in which regions are selected. Correlating may also be based upon the physical location of the user when qualitative data is provided by that user through associating physical location data with the qualitative data, for example.

Correlating can include determining the closeness of qualitative data describing the product to quantitative data describing the product. For example, the qualitative data may include one or more perceived physical parameters of the product while the quantitative data may include one or more measured physical parameters of the product, such as the size of a gap or area or a texture in the product. The qualitative data may be input to the system after measurement by conventional methods. The qualitative data may also be obtained through analysis of one or more images depicting the product, for example, using image processing software. The qualitative data can be analyzed alongside the quantitative data to determine, for example, user perceptions of physical attributes and use such perceptions to improve product design or guide product selection.

Data may be collected and analyzed by any suitable device or combinations of devices. For example, the product quality database may be accessible over a wide-area or local network through the use of one or more servers. User interaction may take place by way of a client device, such as a computer used by the user. The computer may be, e.g., a PC at the user's home, for example. The client device may comprise a kiosk located at a retail location.

A method for providing product selection guidance may include providing a product quality database including information pertaining to a number of products, prompting a user to provide product attribute data, and using the attribute data to identify at least one purchase candidate product from the products listed in the database. The method may further include providing, for each purchase candidate product, an image of the purchase candidate product to the user and providing purchase guidance data associated with the product based on data from the product quality database. The product quality database may include, for at least two different products, product identification data, at least one image of each product, and qualitative data pertaining to each product, wherein at least some of the qualitative data is associated with a particular region of each product. For instance, the qualitative data may be associated with particular areas of an image of each product.

At least some of the purchase guidance data may be graphically indicated in a particular region of the provided image. The user may be prompted to select one or more regions of a purchase candidate product and provide associated qualitative data, and the user-provided data may be added to the product quality database. The qualitative data may be identified with the user that enters the data, and the process of identifying at least purchase candidate product may take into account the user identity, for example, by accessing user preferences regarding similar products. The qualitative data provided by the user may be used to assemble a profile of the user. The profiles may be aggregated and analyzed. For instance, if location data is associated with user data, the profiles may be sorted by location. The method may further include obtaining feedback from the user regarding purchase guidance data. The feedback may be obtained any time after purchase guidance data has been provided. Feedback from one or more users may be used to alter algorithms and software routines used to provide the purchase guidance data.

Providing purchase guidance data may include ranking purchase candidate products relative to one another, with the ranking based at least in part on correlating qualitative data provided by the user to qualitative data associated with the purchase candidate products and provided by other users.

The product attribute data used to select at least one purchase candidate product may be an attribute such as product size, product type, user data such as size measurements, or product information such as brand name or brand family.

The user may view purchase candidate product images and receive purchase guidance data on a computer connected to a wide area or other network, with a server accessing the product quality database and providing the images and guidance data to the user. For example, a web interface may be used. The user may utilize a personal computer, such as a desktop or laptop computer, a cellular telephone, or personal digital assistant, for example. Alternatively, a kiosk including a computer terminal may be provided at a retail location and configured to receive user input and provide data in a user-readable form by accessing the product quality database. The computer terminal may further include an input device configured to read indicia associated with a product, such as a barcode or RFID tag.

A product recommendation system can include at least one server and at least one client device. The server(s) may be configured to access a product quality database and provide purchase guidance data based on retrieving information stored in the product quality database. The server(s) may receive information provided by users by way of the client device. The client device may be programmed to interface with the server(s), receive input from the user and provide the input to the server, and receive purchase guidance data from the server and present it to the user. The server(s) and client device(s) may be configured to perform additional functions, as well. For instance, the server(s) may be configured to implement an e-commerce web site. The client device(s) may then access the e-commerce web site and receive purchase guidance data as part of browsing the e-commerce web site. Furthermore, the server(s) and client(s) may be configured to collect qualitative data from users and add the same to the database.

As used herein, “qualitative data” is meant to include data, in any suitable format, that is reflective of one or more user's subjective impressions.

As used herein, “correlation” is meant to include any statistical or analytical method (including regression, analysis of variance, principal component analysis, supervised classification algorithms, and the like) that one of skill in the art would recognize as being appropriate for modeling one or more relationships of interest.

### BRIEF DESCRIPTION OF THE DRAWINGS

FIG. 1 depicts steps included in an exemplary method of gathering qualitative data;

FIGS. 2A-2D depict an example of an implementation of certain of the steps shown in FIG. 1 as viewed by an end user;

FIG. 3 illustrates an exemplary set of images and an exemplary presentation of obtained qualitative data;

FIGS. 4 and 5 illustrate exemplary forms of presenting qualitative data; and

FIG. 6 shows another exemplary image which may be utilized in gathering qualitative data.

### DETAILED DESCRIPTION

Reference will now be made in detail to various and alternative exemplary embodiments and to the accompanying drawings, with like numerals representing substantially identical structural elements. Each example is provided by way of explanation, and not as a limitation. In fact, it will be apparent to those skilled in the art that modifications and variations can be made without departing from the scope or spirit of the disclosure and claims. For instance, features illustrated or described as part of one embodiment may be used on another embodiment to yield a still further embodiment. Thus, it is intended that the instant disclosure includes modifications and variations as come within the scope of the appended claims and their equivalents.

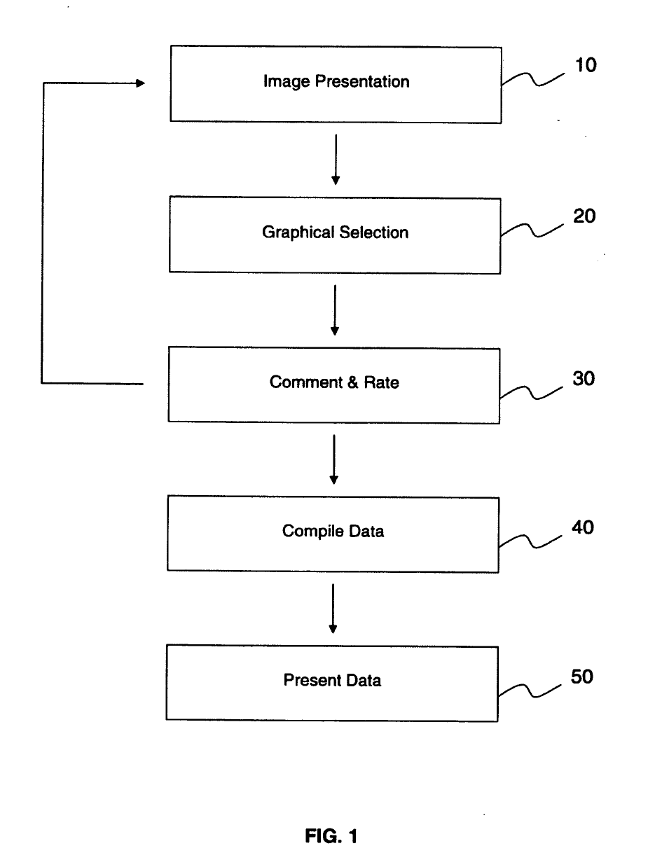

FIG. 1 illustrates exemplary steps in a method of quantifying product attributes. At step 10, an image of a product is presented in a computer format. The image is presented using software which allows for a viewer of the image to select one or more regions of the image in graphical selection step 20. Furthermore, such software is configured to allow qualitative data to be input and associated with the data defining each graphical selection. This is generally illustrated by step 30, “Comment and Rate.” At step 40, the data from a plurality of graphical selections and qualitative data input is compiled and otherwise analyzed. Compilation and analysis may be offline tasks, that is, the compilation and analyzing may take place at a time separate from that of data gathering. On the other hand, however, data could be tabulated and analyzed in real-time, if desired, or a combination of offline and real-time data compilation and analysis could be implemented.

At step 50, information that has been gathered and analyzed may be presented in a human-readable form. One of skill in the art will recognize that data may be presented long after it is gathered and/or analyzed. Furthermore, not all persons providing data will necessarily view the results, nor will all persons reviewing results necessarily have provided data. As will be discussed in further detail below, the information may be provided to entities including the consumer who provides qualitative data, to other consumers, to product designers, to marketing, advertising, and sales personnel, and to other persons in a wide variety of contexts, depending upon particular data needs and applications.

The presently-disclosed subject matter may be implemented by any suitably configured computer system or systems running a survey application. For example, consumer interaction such as presentation of images to a consumer and collecting data may be implemented using a web-based survey application provided from a server with supporting scripts such as Javascript. Alternatively, some or all of the consumer interaction may take place using a standalone survey application, such as a standalone executable file. The survey application may include one or more component or metafiles that direct the operation of other applications running on a computing device.

The survey application may include components downloaded to a computing device over the Internet or another network, components provided via media, such as a CD or DVD-ROM for example, or components that operate over a network environment. The survey application may be implemented entirely on a remote computer, entirely on a consumer computer, or partially on one or more computers.

The consumer may use any suitable computing device, including, but not limited to, desktop, laptop, tablet, and network PCs, cellular telephones, and/or personal digital assistants (PDAs), for example.

Data collected from the consumer can include data defining region selection areas associated with each image presented to the consumer. Furthermore, qualitative data is collected. Qualitative data includes any subjective information provided by the consumer, such as intensity rankings, descriptive text, multiple-choice selections, and freehand drawings, for example. Other useful data that may also be collected may include consumer-specific data such as consumer identification, location or demographic data, and time of the survey. Survey metadata such as order of selection, number and order of images and/or products, the amount of time each image or region was considered, and other information describing the survey process may also be collected.

The survey application may provide all such data to one or more product quality database(s), with the qualitative data associated to particular region(s) (if any) of each particular product selected by the consumer. For example, the data may be associated with coordinates corresponding to portions of the product, such as vector coordinates. In alternative embodiments, qualitative data may be associated with particular coordinates of one or more images of the product. In such embodiments, regions of the product may be defined as certain areas within one or more images of the product. The qualitative data itself may be stored partially or entirely in graphical form, such as in the form of an image.

Data collected from consumer may be stored in one or more product quality databases. Such databases may be implemented using one or more computers, such as servers, running any suitable database program and configured to receive, either directly or indirectly, the consumer data from survey applications. For instance, the product quality database may be supported by a first server configured to receive data from a second server, with the second server configured to interact with consumers via one or more survey applications. Alternatively, a single server could be used. The collected data may be stored in a form so that qualitative data may be accessed based on input specifying a region of a product. For instance, qualitative data may be associated with a particular region or particular regions of one or more images depicting a product. Alternatively, qualitative data may be associated with other data defining portions of a product, for example, physical coordinates of the product itself. In such a case, the physical coordinates may be determined through analysis of region selections in the images, for example. Of course, one of skill in the art will recognize that the database may further include data not associated with particular portions of images or regions of products.

Analysis of the collected data may be performed on the same server(s) housing the database or supporting consumer interaction, or may be implemented using further computing devices. For instance, the product quality data may be downloaded to a computer running appropriate analysis software; alternatively, some or all analysis may be provided as part of the database functionality.

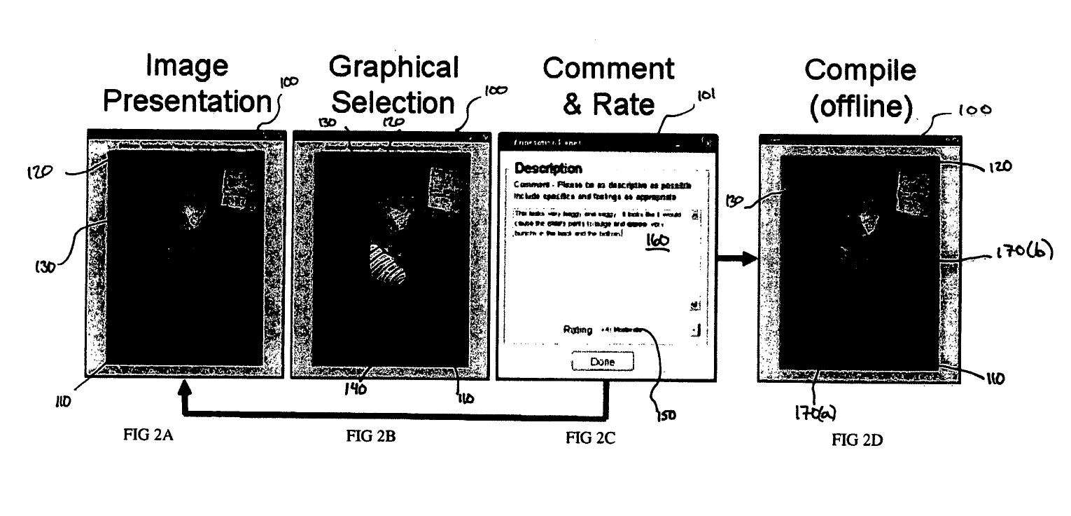

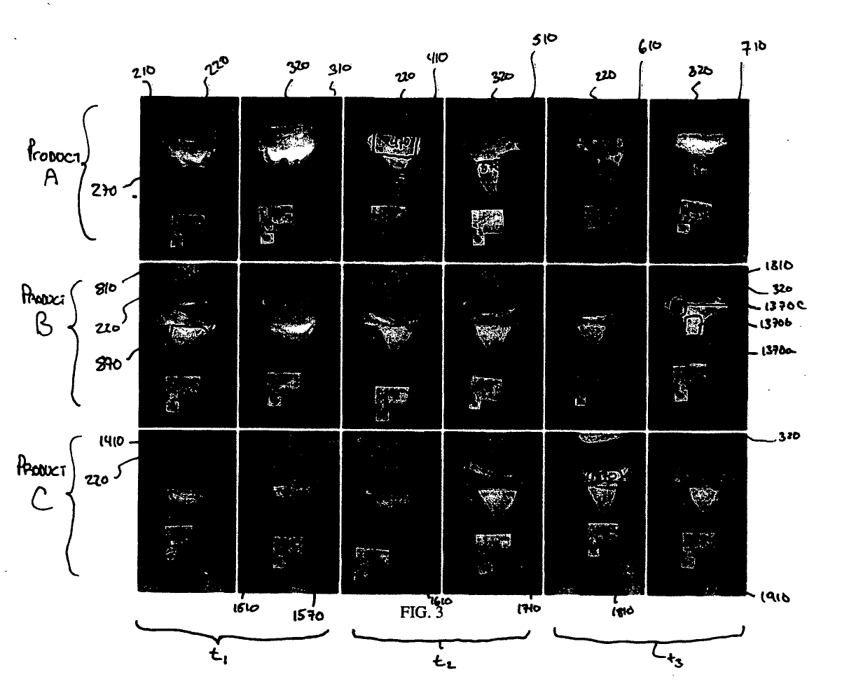

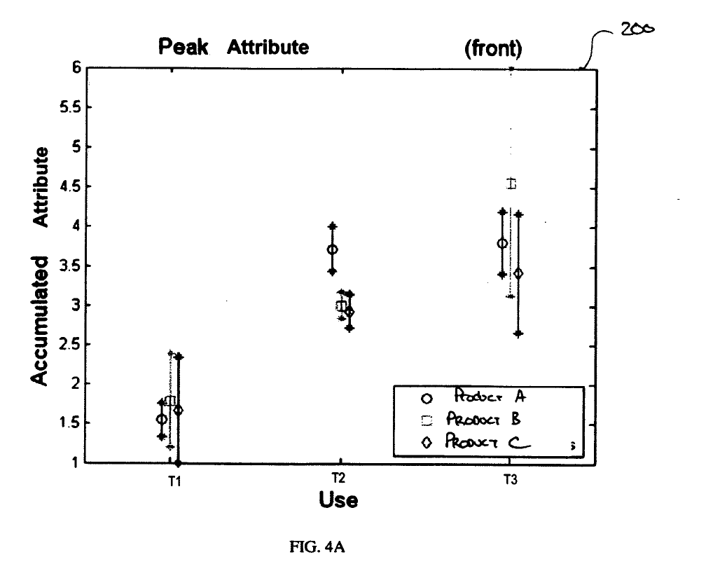

FIG. 2 provides an exemplary illustration of an implementation of a method in accordance with the present disclosure as would be viewed by an entity providing data. The entity may be, for example, a product consumer or focus group participant. An image 110 depicting a user 120 using a product 130 is presented to the consumer via window 100. As noted above, any suitable computing device or combination or computing devices may be used to present information to a consumer and collect data provided by that consumer, so long as the computer system or systems is appropriately configured. In the present example, image 110 depicts a diaper product 130 as worn by baby 120. However, it will be apparent that any type of product and any type of user may be depicted in an image. Furthermore, a product may be depicted alone and not as it would appear in use. As will be discussed below, the image may include a user using a product or may comprise an advertising image simulating the use of the product. The image may include one or more users and/or one or more products.

FIG. 2B illustrates an exemplary view of the graphical selection step 20. User 120 and product 130 are again depicted in image 110 in a window 100. However, graphical selection area 140 is indicated in the lower portion of diaper 130. Selection area 140 represents input by the consumer of a particular area of the image that includes a specific attribute. For instance, the survey software could be configured to prompt the consumer to graphically select a region or regions that appear uncomfortable. Alternatively, the consumer could be prompted to select regions that appear to be comfortable. One or ordinary skill in the art will recognize that data may be obtained not only from areas that are affirmatively selected by a consumer or plurality of consumers, but also by analyzing what areas are not selected by a particular consumer or a plurality of consumers.

The selection data may be obtained in any suitable manner. For instance, the consumer may select an area by freehand drawing, highlighting, or clicking on areas of the image with a mouse, tablet, or touchscreen interface, for example. The regions may be predefined or may be defined by the consumer. For example, the image could be divided into regular or irregular shapes, with each shape defining a region, with consumer input cross-referenced to the predefined regions via a grid or other coordinate system. Alternatively or additionally, the areas could be defined based on pinpointing actual areas selected by the consumer. As a further alternative, predefined regions could be explicitly presented to the consumer for selection or non-selection, for example, by highlighting each of a plurality of regions in sequence and prompting the consumer for a response.

FIG. 2C illustrates a window 101 which may be provided as a part of step 30. Window 101 includes input areas 150 and 160 where the consumer may provide qualitative data pertaining to a region selection. In this example, the consumer is prompted to provide a textual description of specific perceptions associated with the selected area and is further prompted to provide a numerical intensity rating at 150; as will be noted below, the intensity may represent any appropriate attribute(s). The qualitative data may be obtained in a variety of ways.

For instance, the survey software may be configured to generate a qualitative data input window 101 every time a consumer graphically selects an area 140 in the image 110. As another example, the consumer may first select one or more regions 140, with the software configured to present a plurality of qualitative input windows 101 simultaneously or in succession while indicating which window is associated with which graphical selection. Furthermore, qualitative data may be received even if a consumer does not select any regions of an image.

Although exemplary window 101 includes text area 160 and attribute intensity selection rating menu 150, other types of qualitative data may be obtained by other means. For instance, rather than text input, the software could be configured to recognize speech or consumer handwriting and convert the same to text or other machine-recognizable form. Qualitative data could be input in freeform or may be obtained by providing one or more choices of, for example, key words, discomfort intensity levels (or other numerically-indicated attributes), or by providing graphics that could be manipulated to indicate intensity, such as a clickable thermometer or a sliding level indicator.

Although a single image and graphical selection are shown, the survey software may be configured to provide a plurality of different images, including images of the same product and/or user in different views, images of multiple different users using the same product, and images of multiple different users using different products. Each image may depict one or more users and one or more products. Once data has been gathered, the graphical selection data and qualitative data are compiled using a variety of statistical analysis techniques. These techniques may provide a wealth of usable data for a number of different applications.

An example of such data is provided in FIG. 2D, which shows compiled data as presented by a graphical overlay on the original image from FIGS. 2A-2C. As in the prior figures, image 110 depicts subject 120 wearing diaper 130. However, overlaying the image 110 are two regions of interest 170A and 170B. Regions of interest 170A and 170B may comprise, for example, the result of accumulating graphical selections and qualitative data provided by a plurality of consumers. Since several panelists may view the same image and select potentially overlapping regions, there are numerous ways that both the regions and the comments themselves could be weighted, such as according to intensities or order of selection, for example. In FIG. 2D, region 170A may be a different color from region 170B, for example, if consumers who selected region 170A provided different intensity levels than when they selected region 170B. If intensity levels were greater for region 170B, for example, region 170B could be rendered as red while region 170A is rendered as another color, such as orange.

The compiled data may be of great use to a variety of personnel involved with the manufacture and sale of the consumer product 130. For instance, regions 170A and 170B could be further analyzed and could become the subject of a product redesign.

Image processing or morphological operations may be employed to enhance or otherwise alter the image(s) before, during, and/or after any part of the survey process. For example, images may be merged, cleaned, blurred, or otherwise enhanced. Image processing operations may be used to provide additional or more useful data from which to extract features and make product recommendations. For example, this may include binary or grayscale analysis, frequency analysis, and more complicated densitometry. Similar techniques may be used to alter, analyze, and process qualitative data for instances in which the qualitative data itself is stored in graphical form. For example, region selections may be stored as images and the images accumulated to determine regions selected by multiple consumers.

FIG. 3 illustrates the results of an expanded survey using the format discussed in conjunction with FIGS. 1 and 2. FIG. 3 illustrates a total of 18 different images including graphical overlays based on compiling data from a survey of three different products using two different subjects and depicting each product as worn by each subject at three different times. Images 210, 410, and 610 illustrate subject 220 using product A at times T₁, T₂, and T₃, respectively, while images 310, 510, and 710 show subject 320 using product 1 at times T₁, T₂, and T₃, respectively. Images 810, 1010, and 1210 show subject 220 using product B at the respective times, while images 910, 1110, and 1310 show subject 320 using product B at times T₁,-T₃. Finally, images 1410, 1610, and 1810 show subject 220 using product C at times T₁, T₂, and T₃, while images 1510, 1710, and 1910 show subject 320 using product C at those times. For example, products A, B, and C may represent competing brands and/or styles of diapers, while times T₁, T₂, and T₃ may represent pre-use, post-use and overnight use.

The various images 210-1910 may be presented to one or more consumers in the same manner as discussed above in conjunction with image 110. For example, each of a plurality of consumer may be directed to graphically select one or more areas of interest and provide comments and a discomfort rating pertaining to that area of interest. The graphical selections and qualitative data provided by each consumer may be cross-referenced to determine areas that were selected by a plurality of consumers and to indicate a relative measure of intensity. For example, a metric may be applied to the intensity rating provided by each consumer for a particular area to weigh or normalize the intensity data.

Regions of interest may be defined, for example, as areas for which the compiled data exceeds a threshold value. Alternatively, regions of interest may be explicitly defined and data corresponding to those regions may be correlated and displayed. For instance, in FIG. 3, the displayed data is shown as limited as shown to a particular region, such as the crotch area of the diaper. This display may result from a selection of that region for analysis. Alternatively, the display may result from analyzing all data and displaying areas of the highest interest to consumers.

For example, FIG. 3 may represent the end result after perceived attribute intensities provided by consumers corresponding to particular areas are normalized relative to each consumer's other selections and then averaged across consumers. Accordingly, the overlays depicted in FIG. 3 can indicate increasing intensity through changes from dark colors such as purple and blue through greens and yellows up to orange and red, which indicate the highest perceived attribute intensity. By way of example, region 270 in image 210, region 870 in image 810, and region 1570 in image 1510 all indicate relatively low intensity levels for selected areas in the pre-use images for each of products A, B, and C. Turning to images 410 and 510, overlaid regions 470 and 570 both indicate that consumers provided moderate intensity levels for the crotch region of product A in the post-use scenario for both subjects 220 and 320. Images 1310 and 1810 both include relatively intense overlays 1370 and 1870, with overlay 1370 showing particularly high perceived attribute intensity levels.

Results such as those shown in FIG. 3 could be of great use to product designers and/or product marketers. For instance, assume product B represents a product sold by the entity performing the survey. If the perceived attribute intensity data illustrated by overlays such as 1370a-1370c represents a negative attribute, the data could be provided to product designers as a guidepost for points for further improvement in product B. On the other hand, if product B were a competing product, marketing personnel could use the negative attribute data to tailor advertising and other marketing strategy to point out the perceived shortcomings of product B in the scenario depicted by image 1310. As another example, assuming that the overlays show a positive attribute, such as perceived comfort intensity, the overlay areas 1370 could be used as a basis for improving a product or substantiating positive advertising claims related to product B.

Qualitative data may be obtained for any suitable product attribute. For instance, qualitative data may describe the consumer's perceived feelings, perceptions, impressions, or other thoughts regarding the product. Such attributes may include perceived comfort, discomfort, softness, roughness, fit, tightness, looseness, linearity, symmetry, sags/droops, gaps, physical attributes of the product, sturdiness, resiliency, smoothness/wrinkles, agreeability/disagreeability of colors, graphics, images, shapes, product layout, appearance, etc. The attribute or attributes may be measured, for example, by a numerical value indicating perceived intensity. However, other suitable metrics may be employed.

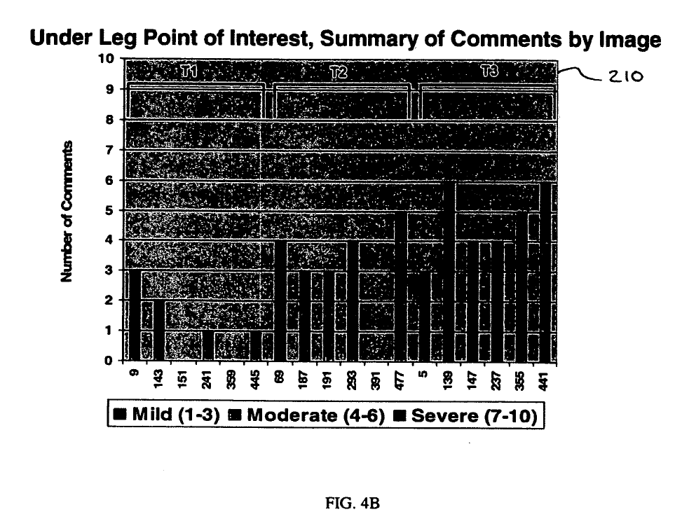

The compiled data may be analyzed in other ways and presented in non-graphical formats to provide still further advantages to consumer product manufacturers. For instance, FIGS. 4A and 4B show two charts, 200 and 210, respectively, based on the accumulated data. For instance, chart 200 shows the average of each panelist's maximum attribute intensity rating to a particular region, in this example, the front of the diaper. Chart 210 indicates a histogram of comments based on side view images, associated with the “under leg” portion of the diaper. As these examples indicate, the data may be analyzed and/or presented on the basis of particular images or by selecting particular regions of images or combinations thereof.

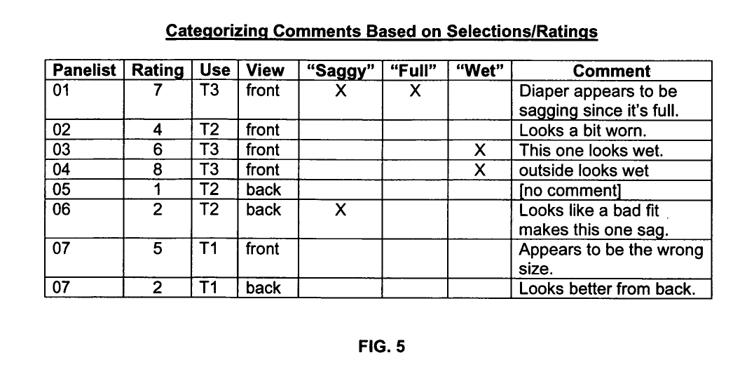

FIG. 5 shows another chart 220 illustrating a further analysis aspect which may be useful for consumer product manufacturers. FIG. 5 illustrates an exemplary chart such as may be generated based on the textual (or other) freeform comments provided by consumers as they select various areas of images. The exemplary chart 220 shown in FIG. 5 includes data from consumer panelists in response to front and back views of the diaper. Chart 220 is broken down by panelists and also indicates the attribute rating, identifies the time case (T1, T2, T3), the view, the actual textual content of the consumer's comments, and a plurality of exemplary key words.

For example, the chart indicates that a match was found in panelist no. 1's textual comment for the key words “saggy” and “full.” One of skill in the art will note that the actual text of “sagging” was cross-referenced to “saggy” by use of, for example, software analysis routines. In this example, panelist no. 5 provided an attribute rating but no text. Furthermore, this example shows that panelist no. 7 viewed two different images (front and back) of the product.

Correlation and analysis of the qualitative data provided by consumers may include a key word search, which may be based, for example, on a list of key words provided by the survey takers. Furthermore, the key word list may be generated dynamically by analyzing comments for a particular region by a plurality of consumers and extracting words that are used at or above a given frequency as is known in the art.

Alternatively, the same images provided to consumers may be presented to internal personnel, such as product designers, engineers, sales personnel, or others, and such internal personnel may be prompted to provide descriptive words using internal terminology. For example, consumers may describe a particular region of a garment as “wrinkly,” while a product design engineer may use a different term, such as “creped” for the same region. Other internal data may include internal terminology for product regions, component names, part numbers, product and/or part measurements, and material attributes, such as composition, for example. Qualitative consumer data from the database may be correlated with internal data to provide more closely-tailored suggestions or comments to designers. Furthermore, the internal data may be used as the basis for sorting and analysis of the data provided by consumers. The internal data may be gathered in a manner the same as or similar to the data gathered from consumers.

Correlation may include analysis and processing of graphical data contained within the images themselves. In one embodiment, graphical data could be evaluated using image analysis and processing and then correlated with consumer-provided data. For example, consumer selections could be scored against light and dark areas of an image to determine the influence the contrast or composition of the image has on responses.

As another example, consumer selections indicating degrees of one or more attributes, “wrinkliness,” for example, could be cross-referenced with areas having a particular pattern of dark and light pixels. Varying degrees of “wrinkliness” could then be scored throughout the image (and in other images) based on identifying pixel attributes with consumer perceptions. As a further example, quantitative measurements, such as sizes of gaps, product areas, etc. could be correlated to consumer perceptions.

For instance, for a wearable product, images showing varying gaps between the product and the user could be evaluated to determine how big the gap would have to grow before consumers perceived a problem. The gap size could be based on quantitative measurements provided to the system and cross-referenced to the image. Alternatively, the gap size may be measured by analyzing the image itself.

Accordingly, the system may include a toolset for extracting qualitative data about the product(s), user(s), or other subjects depicted in the image, and such qualitative data could then be analyzed and correlated to qualitative data provided by system users. For instance, such measurements may be based on 2D or 3D analysis of one or more images of the product. As noted above, the system may additionally or alternatively provide for the input of measured physical parameters, such as physical measurements of the product taken at the time images of the product are produced.

Correlation may include analyzing qualitative data including suggested changes or improvements to the product. For example, consumers may be presented with various styling choices or feature combinations for an automobile and may be prompted to choose the most desirable. Alternatively, the consumers may be prompted to provide suggested changes in color schemes, for instance.

A product quality database may, as noted above, provide a wide variety of avenues for improvement of product design features as well as improvements in tailoring marketing and advertising strategy. Furthermore, such a database may be useful as a component in a computer-based system that allows for both product marketing as well as collection of qualitative data while also providing purchase guidance to consumers.

For instance, a product quality database could be assembled in accordance with the subject matter discussed above, such that the product quality database includes data identifying at least two products and qualitative data about each product, with at least some of the qualitative data associated with particular regions or parts of each product. As noted above, the qualitative data could be associated with particular parts of each product by way of particular areas of an image or images of such products, or by way of other means such as vector coordinates. The product quality database could include data pertaining to a wide variety of products across multiple fields and multiple manufacturers. Furthermore, the database could include one or more images of each product. The qualitative data in the product quality database may be obtained from consumers. However, the data may be obtained in whole or in part from other sources, such as from personnel associated with providing the product.

A purchase guidance system may include one or more computers configured to prompt a consumer to provide product attribute data. The product attribute data may comprise any suitable identification of a product, such as the product name, the product brand name, a brand family which includes the product, or an inventory or other identification number, for example. Furthermore, product identification data could include user-specific data, such as sizes or other user measurements. The product attribute data may be only a rough indicator of desired product traits, which could be especially useful if a name or other designation is unknown. Based on the product attribute data, the system could be configured to correlate the attribute data with data associated with products and stored in the product quality database to determine one or more purchase candidate products.

For example, a user could select “diapers” and provide a size or range of sizes. Based on the data provided by the consumer, the database may return one or more products matching the criteria, e.g., a variety of different types of diapers in matching or close-to-matching sizes. The system can provide further information about these returned products (referred to as “purchase candidate products” herein), such as one or more images of each purchase candidate product, and other purchase guidance data associated with the product. In addition to the images, the purchase guidance data may include, for example, product price, use and care instructions, or other information about the product. For example, the purchase guidance data may include information obtained by correlating qualitative data provided by other consumers in association with particular regions of the product.

Furthermore, the purchase guidance system may also prompt the consumers to select a region of a purchase candidate product and provide associated qualitative data. Such data may then be added to the product quality database for further analysis as discussed herein.

The system may be configured to recognize particular consumers and identify qualitative data with the particular consumer providing the data. For instance, the system may prompt the consumer for identification data prior to providing purchase guidance data. Providing purchase guidance data can include accessing qualitative data provided by the particular consumer in the past and using that data as a basis for providing purchase recommendations or purchasing guidance data.

For example, if the consumer had indicated a certain area on a diaper of first size as bulky, tight, or otherwise undesirable, such data may be added to the product quality database associated with that particular diaper and stored for later use. If the same consumer later requests a recommendation for a diaper of a second size, the system could consider that particular consumer's dislike for aspects of the diaper of the first size when making the purchase recommendation. For instance, assume the consumer indicated the leg area of a certain style of diaper to appear tight when shopping for a diaper of a first size. Later, if the consumer requests a diaper of a larger size (for instance, to accommodate a growing infant), the system may exclude diapers of the non-preferred style.

One of ordinary skill in the art will recognize that many statistical techniques, including discriminant analysis, clustering, supervised learning algorithms, and the like exist to classify consumers on the basis of their qualitative data and to aid in the recommendation process.

The system may even be configured extrapolate preferences from one style of product to another based on the qualitative data. Using the above example, if the non-preferred region of a particular style of diaper is correlated to a certain component or material of the diaper, such as a particular liner type, the system may exclude or provide lower rankings to diapers of other styles using that same component or material.

As a further example, the product quality database may include data pertaining to clothing products. Such data could include qualitative data indicating certain preferred styles in casual wear clothing as provided by a particular consumer. Such data could be used when the same consumer is selecting business clothing or swimwear, for example, such as preferred color combinations and the like. The system may include factors that weigh how “close” to product categories are. For instance, casual wear and business clothing may be considered closer than business clothing and swimwear, while clothing and any sort of tool or personal care product would be considered not to be close. Nonetheless, even seemingly-disparate products may share attributes for which consumer preferences may be considered; for example, a consumer may prefer certain color schemes in home furnishings that complement his or her clothing selections.

The purchase guidance system may be configured to create profiles of consumers based on recommended products, previously-provided purchase guidance data, and other consumer data. For example, as noted above, a purchase guidance system may be configured to track consumer preferences as to clothing style by generating a profile that includes various preferred clothing styles and combinations. The system may further be configured to track the consumer's style over time and cross-reference it to other consumer profiles and demographic data. The system may also be configured to aggregate profiles for a plurality of consumers to track trends across demographic groups, such as ages, income levels, locations, and the like. The system may also recommend additional items based on selection or other feedback provided during the recommendation process.

Furthermore, after one or more products have been recommended, the system may prompt the consumer for feedback as to whether the guidance data is accurate. Using the example noted above, after recommending a particular diaper, the system may inquire as to whether the consumer plans to purchase the recommended diaper. The feedback may be obtained at a later time. For example, assuming the consumer purchases diapers a week later, the system may inquire as to whether the recommended diaper was a good buy or request input as to where the recommendation was inaccurate. By “remembering” consumers, the system may further be capable of obtaining long-range data about product use and changing consumer perceptions of the product as it is used.

Consumer feedback may be used to fine-tune software routines, algorithms, and other components used in implementing the purchase guidance system. For example, the feedback may be used to train neural networks or expert systems used in generating the purchase guidance. The feedback may be used to customize routines for individual consumers or groups of consumers. For example, if feedback across a wide variety of system users indicates bad recommendations, the algorithms may be altered and/or the problem may be brought to the attention of human personnel.

Consumer profiles may be accessed by the system as part of making purchase recommendations or otherwise providing purchase guidance data. The profiles may also be analyzed individually and/or in aggregate to extrapolate consumer trends. For instance, if the profiles include location data, the profiles may be sorted and otherwise analyzed on the basis of location. As noted below, the purchase guidance system may be implemented to operate in a retail environment. The profiles could be analyzed and the data provided to an entity or entities responsible to the retail environment, and may be correlated with data collected from the retail entities, for example, purchase data.

The product selection guidance system may be implemented using one or more computer systems and databases, for example, using one or more computer servers with access to the product quality database or databases. The consumer who desires product selection guidance could then access the server by way of a client computing device. The client device may comprise a desktop computer, a laptop computer, a tablet computer, a network computer, a personnel digital assistant (PDA), a mobile telephone, or any other capable device. For example, the purchase guidance system may be incorporated into an e-commerce site accessed using the client device via the internet.

Alternatively, the consumer may access the purchase guidance system by way of a client device located, for example, at a retail location. For example, the client device may be implemented as a kiosk including an appropriate network connection to the purchase guidance server and/or other suitable connections for accessing the purchase guidance database. The kiosk may be located at the point of purchase or in an area or areas of the retail location at which consumers are confronted with a choice in products. The kiosk may be configured to obtain data from consumers, for example, by keyboard, mouse, touchpad, or other input means. For instance, the kiosk may include a barcode and/or RFID or other scanning device to obtain information from indicia on an actual product located in the store. The kiosk may then access the product quality database and provide purchase guidance data based on the indicia.

For example, the consumer could choose a roll of paper towels and scan the barcode or RFID tag associated with the roll of paper towels. The purchase guidance system could then provide information about the particular type of paper towels indicated, as well as competing types indicated to have similar characteristics. The consumer could identify himself to the system, for example by scanning a shopping loyalty card or other identification, and the system could access stored preference attributes and/or stored profiles for that consumer and further refine the recommendation.

The client device may be part of a vending machine or other delivery system configured to physically present products to the consumer upon purchase. For example, a vending machine may include a touch-screen panel interfaced to a server running a purchase recommendation application. The consumer may interact with the purchase recommendation system to determine which product best suits his or her needs, and upon receiving a recommendation, may complete the purchase transaction with the vending machine.

The server(s) and client device(s) may be implemented as part of an e-commerce system. For example, an online store may be maintained using one or more servers to present an online storefront to consumers using client devices such as PCs. The online store may be further configured to access the purchase guidance system as part of the purchase process. Alternatively, the purchase guidance system may be accessed by client devices and provide links to the online store to purchase the recommended item(s).

Thus far, the present disclosure has provided examples of use of a system in conjunction with consumer products, such as diapers, paper towels, and the like. However, one of ordinary skill in the art will recognize that the system is equally applicable for use with other consumer products not discussed herein. For example, vending machines are now available to sell consumer electronics, such as music players. Consumer electronics in any context (including vending machines) often confront consumers with a wide variety of possible choices and configurations, and accordingly a product recommendation system could be advantageous in the sale and marketing of consumer electronics.

By way of non-limiting example, the methods and systems discussed herein may be utilized to gather, analyze, and process data and/or make recommendations for products including, but not limited to: apparel, appliances, accessories, baby products, cleaning products, collectables, computers, cosmetics, decorative items, electronics, fitness equipment, food and food products, footwear, fixtures, furnishings, hardware including tools, home and garden products, household supplies, jewelry, personal care products, sporting goods and equipment, telephones and other communications equipment, toys, and vehicles of all sorts.

Furthermore, the system is suitable for use in determining consumer desires and preferences with regard to non-consumer products. For example, purchasers and users of industrial and commercial-grade equipment may have needs and desires with regard to product attributes that may be ascertained using the present subject matter.

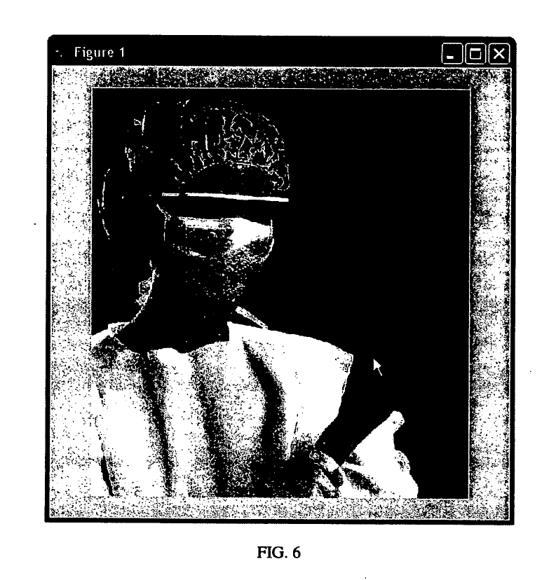

The methods and systems discussed herein may also be useful in assessing consumer perceptions in contexts other than those involving perception of products. For example, the system could be used to evaluate consumer perceptions of certain areas or aspects of advertising images, for example. FIG. 6 illustrates an exemplary advertising image depicting a plurality of healthcare products. Images such as the one shown in FIG. 6 could be presented to a plurality of healthcare product consumers and qualitative data could be obtained from such consumers and correlated to specific parts of the image. For example, consumers could indicate that certain aspects of the image appear uncomfortable, such as the surgical cap. Such data could be useful from a marketing standpoint, for example, if the advertisement did not even pertain to the surgical cap. For instance, if the advertisement is for the surgical glove, the data could be used to justify depicting an advertisement without the surgical cap, or a different surgical cap. Another exemplary type of analysis could consider which portions of the advertising image are selected by consumers first, to determine where the most prominent feature should be placed in an image.

The technology discussed herein makes reference to servers, databases, software applications, and other computer-based systems, as well as actions taken and information sent to and from such systems. One of ordinary skill in the art will recognize the inherent flexibility of computer-based systems allows for a great variety of possible configurations, combinations, and divisions of tasks and functionality between and among components. For instance, server processes discussed herein may be implemented using a single server or multiple servers working in combination. Databases and applications may be implemented on a single system or distributed across multiple systems. Distributed components may operate sequentially or in parallel. When data is obtained or accessed between a first and second computer system or component thereof, the actual data may travel between the systems directly or indirectly. For example, if a first computer accesses a file from a second computer, the access may involve one or more intermediary computers, proxies, and the like. The actual file may move between the computers, or one computer may provide a pointer or metafile that the second computer uses to access the actual data from a computer other than the first computer, for instance.

The technology referenced herein also makes reference to the relay of communicated data over a network such as the internet. It should be appreciated that such network communications may also occur over alternative networks such as a dial-in network, a local area network (LAN), wide area network (WAN), public switched telephone network (PSTN), the Internet, intranet or Ethernet type networks and others over any combination of hard-wired or wireless communication links.

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

What is claimed:

1. A method of quantifying product attributes, the method comprising:
obtaining data from at least one user, wherein obtaining includes:
graphically presenting at least one image, each image depicting at least one product;
prompting the user to select at least one region of at least one product and storing data defining each region selection in a computer-readable form; and
for each selected region, prompting the selecting user to provide qualitative data associated with the selected region and storing provided qualitative data, if any, in a computer-readable form, wherein storing includes associating the qualitative data with its respective selected region.

2. The method as set forth in claim 1, wherein the data defining at least one region selection includes coordinates identifying an area in at least one of the presented images.

3. The method as set forth in claim 1, wherein prompting the user includes prompting the user to select a first region of a product associated with a first attribute and prompting the user to select a second region of the product associated with a second attribute.

4. The method as set forth in claim 1,
wherein data is obtained from a plurality of users; and
wherein the method further comprises correlating at least a portion of the qualitative data provided by the plurality of users and at least a portion of the data defining region selections provided by the plurality of users.

5. The method as set forth in claim 4, wherein the qualitative data includes perceived comfort attributes of a product.

6. The method as set forth in claim 4, wherein correlating includes determining the extent to which multiple users select the same areas of a product.

7. The method as set forth in claim 4, wherein correlating includes defining at least one region of interest for a product.

8. The method as set forth in claim 7, wherein:
the qualitative data provided by each user includes intensity values indicating perceived intensity of an attribute;
defining a region of interest for a product includes applying a metric to the intensity values; and
wherein the method further comprises displaying a color overlaying a region of interest in an image of the product based on the metric results.

9. The method as set forth in claim 8, wherein the metric includes weighing intensity values such the metric determines where in the image a plurality of different users selected substantially the same area and provided extreme intensity values for that area, relative to other selected areas.

10. The method as set forth in claim 7, wherein defining a region of interest includes applying a metric to determine where a plurality of different users selected substantially the same region of a product.

11. The method as set forth in claim 4, wherein correlating includes tracking the order in which each user provides data.

12. The method as set forth in claim 11, wherein correlating includes, for instances in which a user selects multiple regions, tracking the order in which the user selects the regions.

13. The method as set forth in claim 4, further comprising associating user location data to the qualitative data and region selection data provided by each user;
wherein correlating is based in part on the physical location data;
wherein user location data indicates the physical location of the user at the time information is obtained.

14. The method as set forth in claim 13, further comprising presenting user-readable data based on the correlated qualitative data and the location data.

15. The method as set forth in claim 4, wherein the qualitative data includes descriptive text.

16. The method as set forth in claim 15, wherein correlating includes determining the extent to which a plurality of users use substantially similar text to describe substantially similar selected regions.

17. The method as set forth in claim 15, further comprising:
associating internal attribute descriptions with at least one region of the product; and
correlating at least one internal attribute description associated with the region to user-provided descriptive text associated with the region.

18. The method as set forth in claim 4, further comprising storing the qualitative data in a product quality database accessible using a wide-area network.

19. The method as set forth in claim 18, wherein data is obtained from at least one user using a client device interfaced to a server remote from the client device, wherein the server is configured to access the product quality database.

20. The method as set forth in claim 19, wherein the client device is located at the user's home.

21. The method as set forth in claim 19, wherein the client device comprises a kiosk located at a retail location.

22. The method as set forth in claim 4, wherein the qualitative data includes data indicating at least one desired change to the product at the selected region.

23. The method as set forth in claim 4, wherein correlating includes determining the closeness of qualitative data describing the product to quantitative data describing the product.

24. The method as set forth in claim 23, wherein the qualitative data is a perceived physical parameter of the product and the quantitative data is a measured physical parameter of the product.

25. The method as set forth in claim 24, wherein the quantitative data is measured by analyzing the image of the product.

26. A method for providing product selection guidance, the method comprising:
providing a product quality database including, for each of at least two products:
product identification data, and
qualitative data pertaining to the product, at least a portion of the qualitative data associated with a particular region of the product;
prompting a user to provide product attribute data;
correlating the attribute data and the product identification data to identify at least one purchase candidate product; and
for each purchase candidate product:
providing an image of the purchase candidate product to the user, and
providing purchase guidance data associated with the product based on the qualitative data.

27. The method as set forth in claim 26, wherein providing a product quality database includes providing, for each product, at least one image of the product, wherein the qualitative data is associated with a particular area in at least one image.

28. The method as set forth in claim 27, wherein at least some of the purchase guidance data is graphically indicated in a particular region of the provided image.

29. The method as set forth in claim 26, further comprising:
prompting the user to select a region of at least one purchase candidate product and provide associated qualitative data; and
adding the qualitative data to the product quality database.

30. The method as set forth in claim 29, further comprising associating the qualitative data with data identifying the user.

31. The method as set forth in claim 30, wherein correlating includes accessing previously-provided qualitative data associated with the user.

32. The method as set forth in claim 31, further comprising assembling a profile for at least one user based on qualitative data associated with the user.

33. The method as set forth in claim 32:
wherein the profile includes, for each user, data identifying the user's location at the time qualitative data is provided;
wherein the method further comprises assembling a profile for a plurality of users; and
wherein the method further comprises analyzing user profiles by location.

34. The method as set forth in claim 29, wherein:
at least two purchase candidate products are identified; and
providing purchase guidance data includes providing to the user a ranking of the purchase candidate products relative to one another, the ranking based on correlating qualitative data provided by the user to pre-existing qualitative data associated with the purchase candidate products.

35. The method as set forth in claim 26, wherein the product attribute data includes at least one attribute selected from the following group: product size, user measurements, product type, brand name.

36. The method as set forth in claim 26, further comprising, after providing purchase guidance data, prompting the user for feedback indicating whether the purchase guidance data is accurate.

37. The method as set forth in claim 36, wherein the user is prompted for feedback at the beginning of a purchase guidance session, and wherein the feedback is based on purchase guidance data provided in a prior purchase guidance session.

38. The method as set forth in claim 37, further comprising altering software routines used in providing purchase guidance data based on the feedback.

39. The method as set forth in claim 26, wherein data is obtained from the user by way of a client device interfaced to a server over a wide-area network, wherein the server has access to the product quality database.

40. The method as set forth in claim 39, wherein the client device comprises a personal computer, cellular telephone, or personal digital assistant (PDA).

41. The method as set forth in claim 39, wherein the client device comprises a kiosk situated at a retail location.

42. The method as set forth in claim 41, wherein the kiosk includes an input device, and wherein the input device is configured so that a user can provide product attribute data by using the input device to read indicia associated with a product.

43. The method as set forth in claim 42, wherein the indicia comprises a bar code or an RFID tag.

44. A product recommendation system, the system comprising:
at least one server configured to access a product quality database and provide purchase guidance data based on data retrieved from the product quality database;
at least one client device including an input device and a display, wherein the client device is configured to carry out steps including:
interface with the at least one server,
receive input from at least one user using the input device and provide said input to the at least one server, and
receive purchase guidance data and provide said data to the user.

45. The product recommendation system as set forth in claim 44, wherein the client device comprises a kiosk situated at a retail location.

46. The product recommendation system as set forth in claim 44, wherein the client device is integrated into a product delivery system.

47. The product recommendation system as set forth in claim 44, wherein the at least one server is further configured to implement an e-commerce site.
